(19) United States
(12) Patent Application Publication
(10) Pub. No.: US 2021/0164861 A1
(43) Pub. Date: Jun. 3, 2021

(54) A METHOD FOR TESTING THE STATE OF AT LEAST ONE INTERNAL REINFORCEMENT ELEMENT OF A LIQUID TANK OF A VEHICLE

(71) Applicant: Plastic Omnium Advanced Innovation and Research, Bruxelles (BE)

(72) Inventors: Paul Daniel REUTHER, Bruxelles (BE); David HILL, Bruxelles (BE); Antoine CHAUSSINAND, Bruxelles (BE)

(73) Assignee: Plastic Omnium Advanced Innovation and Research, Bruxelles (BE)

(21) Appl. No.: 17/265,741

(22) PCT Filed: Aug. 6, 2019
(86) PCT No.: PCT/EP2019/071130

§ 371 Date: Feb. 3, 2021

(30) Foreign Application Priority Data
Aug. 6, 2018 (EP) 18187604.6

(51) Int. Cl. G01M 3/32; B60K 15/03

(52) U.S. Cl. CPC G01M 3/3245; B60K 2015/0319; B60K 2015/03217; B60K 15/03

(57) ABSTRACT

A method tests the state of an internal reinforcement element connecting two opposed walls of a liquid tank including an initial amount of liquid measurable by a level sensor. The method includes: determining a first threshold based on the initial amount of liquid and an initial internal pressure of the liquid tank; monitoring a level sensor output and a pressure sensor output; if the pressure sensor output is above the first threshold, determining a second threshold and a third threshold; comparing the level sensor output to the second and third thresholds; if the level sensor output is above the second threshold, sending a first predetermined signal indicating that the internal reinforcement element is broken, and/or if the level sensor output is below a third threshold, sending a second predetermined signal indicating that the internal reinforcement element is broken.

The invention relates to a method for testing liquid tanks, such as vehicle fuel tanks.

Fuel tanks often require an internal reinforcement structure such as welded pillars or an external structure such as a weld on patch. During an accident that is not severe enough to warrant an obvious tank replacement, the internal reinforcement structure could be damaged such that, if left undetected, it could cause noise or, in the worst case, could compromise the integrity of the tank after repeated cycling. We do not know any way to detect such damage without tank disassembly and internal inspection. Tank disassembly is not desirable as it is time consuming, expensive, and complex. Nevertheless, detecting a broken internal reinforcement element in a tank could protect the driver against the risk of a future leak, liquid carry over, or loss of venting and burst, depending on the nature of the damage.

The present invention aims to provide a testing method addressing those drawbacks.

The invention relates to a method for testing the state of at least one internal reinforcement element of a liquid tank of a vehicle, said at least one internal reinforcement element connecting at least two opposed walls of the liquid tank, the liquid tank comprising at least an initial amount of liquid measurable by a level sensor, the method comprising the following steps:

a) determining a first threshold based on the initial amount of liquid measured by the level sensor and an initial internal pressure of the liquid tank measured by a pressure sensor;

b) monitoring a level sensor output and a pressure sensor output;

c) If the pressure sensor output is above the first pressure threshold, determining a second pressure threshold and a third pressure threshold as a function of the pressure sensor output, the initial level sensor output and the initial internal pressure sensor output;

d) comparing the level sensor output to the second and third level thresholds;

e)—if the level sensor output is above the second level threshold, sending a first predetermined signal indicating that at least one internal reinforcement element connecting the opposed walls is or may be broken, and/or
if the level sensor output is below a third level threshold, sending a second predetermined signal indicating that at least one internal reinforcement element connecting the opposed walls is or may be broken.

This method helps to determine a state of the tank and more particularly a state of the internal reinforcement element. For example, it may indicate that the break of at least one internal reinforcement element is suspected. The method relies on the pressure evolution and volume evolution which information are caught by sensors generally available on the system. Accordingly, it is not costly.

The two opposed walls are preferably the bottom and the top walls. It may be provided that the opposed walls are two lateral walls of the tank.

The initial amount of liquid measurable by the level sensor ensures that there is at least a minimal detectable amount of liquid in the tank before the method is performed so that the method can be performed. For example, the method will not be effective if the tank does not contain any liquid.

The initial internal pressure of the liquid tank is preferably equal to atmospheric pressure. As the initial amount of liquid is measured at atmospheric pressure, there is no initial deformation of the tank which increases the accuracy of the method.

The first threshold may be higher, lower or equal to atmospheric pressure. For example, the first threshold may be higher than the initial pressure +50 mbar or lower than the initial pressure −50 mbar. Preferably, the first threshold is higher than the initial pressure +100 mbar or lower than the initial pressure −100 mbar. More preferably, the first threshold is higher than the initial pressure +200 mbar or lower than the initial pressure −200 mbar.

“Initial” means a first measurement whatever the moment of the measurement. The measurement may for example be performed when a power of the vehicle is on or before an accident or a crash.

The signal may for example be an audio or visual signal.

Thus, the signal alerts an operator or the driver, for example, by indicating that the at least one internal reinforcement element is or may be broken. The operator or the driver may subsequently take the measures in order to confirm and/or to fix this failure. For example, the visual signal may be a light or a message displayed on the dashboard. In an alternative embodiment, it may be provided that the signal does not specifically indicates that at least one internal reinforcement element is or may be broken but only indicates that there is a failure requiring a reparation.

The monitoring of the level sensor output and the pressure sensor output may be a continuous or a punctual monitoring.

The evaluation of the second and the third thresholds may be done by mapping. There may be a table linking the initial internal pressure and the initial amount of liquid to the first threshold. Thus, the level of liquid inside the tank may be compared to an expected level as a function of the pressure inside the tank.

It may be provided that, if none of the two conditions of step e) are fulfilled, then a predetermined signal indicating that at least one internal reinforcement element is not broken is sent.

The liquid tank may for example be a tank for fuel, urea or water.

Preferably, during step c), the determination of the second and third thresholds is done also as a function of a temperature of the liquid in the tank.

Thus, the evaluation of the second threshold or of the third threshold is more accurate as the temperature may have an influence on the level of liquid in the tank. Indeed, an increase in temperature leads to liquid dilation, i.e. to a thermal expansion of the liquid. Thus, for example, an increase in temperature leads to an expected increase of the level of liquid in the tank.

Advantageously, the method comprises a step of incrementing a counter if the level sensor output is between the second threshold and the third threshold.

Preferably, if the counter is below a fourth predetermined threshold, at least the steps a), b) and c) of the method are performed again, preferably with a plurality of first thresholds.

Thus, the significance of the method is increased.

Advantageously, if the counter is above the fourth threshold, the method comprises a step of sending a signal indicating that at least one internal reinforcement element connecting the opposed walls is not broken.

Thus, a repetition of the method is forced so as to ensure that statistically the method has been run a sufficiently high amount of times such as it met the conditions to validate that at least one internal reinforcement element is not broken. This is particularly interesting when the method relies on natural pressure variations inside the tank.

Preferably, the monitoring step b) relies on an increase or a decrease of pressure inside the tank generated solely by an increase or a decrease of an external tank temperature.

Thus, the method relies on temperature variations due to the environment of the tank, possibly natural variations, and there is no additional element needed to run it. In this case, the first threshold is preferably higher than the initial pressure +100 mbar or lower than the initial pressure −100 mbar.

Preferably, the monitoring step b) comprises a step of commanding means for increasing or decreasing pressure inside the tank, preferably in response to a signal from a vehicle crash sensor.

Here the pressure variation is commanded and not solely the result of a variation from the environment, or better said, driven by the environment. Thus, the realization of the method is more controlled as the pressure target, i.e. the first threshold, will be reached upon command. Accordingly, it is possible to trigger the method whenever it is wanted or needed. This method is shorter than the method based on the environment pressure evolution, or better said, driven by the environment. In the embodiment in which the step of commanding means for increasing or decreasing pressure inside the tank is performed in response to a signal from a vehicle crash sensor, the method is mandatory done when an event monitored by an external sensor, for example a crash sensor, suspects an impact. The sensor could be for example an accelerometer used for an airbag or a dedicated one.

More preferably, the step of commanding means for increasing or decreasing pressure inside the tank is performed by:

using an external pump not forming part of the vehicle;

using a means forming part of the vehicle, for example a pump or a heater, and/or

commanding a release of the internal tank pressure using a valve of the tank.

When an external pump not forming part of the vehicle is used, this external means could apply pressure inside the tank during service and request the diagnostic to be done. It may be provided that the control of a valve (for example a Fuel Tank Isolation Valve (FTIV) or a purge valve) of the system allows the pressure from the external pump to be applied on the system. The external pump is able to apply positive and/or negative pressure. When an external pump not forming part of the vehicle is used, the first threshold may for example be higher than the initial pressure +100 mbar, preferably the first threshold is higher than the initial pressure +200 mbar.

A means forming part of the vehicle is a means which already exists in the vehicle for another purpose, for example a leak detection pump, a canister purge pump, an engine manifold vacuum, or other. Thus, it is not costly and there is no external intervention needed. When a means forming part of the vehicle is used, the first threshold is preferably higher than the initial pressure +50 mbar or lower than the initial pressure −50 mbar.

When commanding a release of the internal tank pressure is performed using a valve of the tank, the use of an existing valve, such as a FTIV or an E-valve is possible and is not costly and there is no external intervention needed. A valve may only be used for decreasing pressure but the occurrence of the release of pressure may for example be linked to refueling events. In this case, the first threshold is preferably equal to atmospheric pressure.

Advantageously, the method is performed when a power of the vehicle is off, preferably only when a power of the vehicle is off.

Thus, the slosh of liquid inside the tank is limited. The slosh designates the liquid waves inside the tank which create noise on the fuel level measurement. The level sensor should not be dynamically moving for the method to be as relevant as possible. Thus, avoiding slosh increases the accuracy of the level measurement.

Preferably, the method is triggered when the vehicle is in a service mode.

Thus, the method is performed when the information is especially useful. Thus, the tank could be investigated more deeply and changed if needed. For example, the method is triggered by an external computer.

Advantageously, a leak detection step is performed before step a).

The leak detection step tests the tank shell integrity. In case of passive system (e.g. the increase or decrease of pressure is based on variations of external temperature), the test which is normally done with a constant tank volume fails as there is a volume change due to the break of the internal reinforcement element.

A leak detection method aims to detect a leak in a liquid tank of a vehicle. An example of leak detection method is described in JP 2013-019396A.

The invention also relates to a method for testing the state of at least one internal reinforcement element of a liquid tank of a vehicle, said at least one internal reinforcement element connecting at least two opposed walls of the liquid tank, the method comprising the following steps:

performing a leak detection step, and

if a result of the leak detection step is of a predetermined type, sending a signal indicating that at least one internal reinforcement element connecting at least two opposed walls of the liquid tank may be broken.

Advantageously, the predetermined type of the result is a result that indicates that a leak is suspected. This result may be derived from the outcome of the leak detection method. If the leak detection reveals a problem, it can be due to an unexpected volume variation generated by a broken internal reinforcement element. Thus, this method could help repairing the liquid tank—also called the liquid system—for instance, the fuel system.

Alternatively, the predetermined type of the result is a result derived from the outcome of a leak detection method that indicates that at least one internal reinforcement element may be broken, while no leak is detected. This can be achieved by pumping air into or out of the liquid tank to pressurize or depressurize it and measuring the internal pressure of the liquid tank. If no leak is suspected after a leak detection method is performed, then the method comprises the step of defining a relationship between:
the air volume pumped into or out of the liquid tank, named Vₐᵢᵣ(t),
the vapor dome volume, named V_{dome}(t), and,
the internal pressure of the liquid tank, named Pᵢₙₜ(t), and comparing a value C(t) computed using the aforementioned relationship, to a predetermined threshold, wherein t in brackets means that the parameters of concern are time-dependent. The predetermined threshold can be, for example, a calibrated value computed using the aforementioned relationship when the state of the tank is known as not damaged.

The air volume Vₐᵢᵣ(t) is inferred from the pump performance Fₚᵤₘₚ(t) and the pump activation duration Δt_{act}, whereas the vapor dome volume V_{dome}(t) is calculated as the difference between the total liquid tank volume Vₜₒₜ(t) and the liquid volume in the liquid tank, named V_{liquid}(t), as follows.

V_{dome}(t)=Vₜₒₜₐₗ(t)−V_{liquid}(t)

The pump performance Fₚᵤₘₚ(t), is defined as a parameter depending on following parameters such as the air volume Vₐᵢᵣ(t), the pump efficiency and the pump current consumption.

For example, the value C(t) can be computed according to the following steps:
Step 1: multiplication of the energy consumption of the pump, Eₚᵤₘₚ(t), by the pump performance, Fₚᵤₘₚ(t), a parameter depending on the air volume Vₐᵢᵣ(t), and by the internal tank pressure Pᵢₙₜ (t), in order to obtain A(t).

A(t)=Eₚᵤₘₚ(t)*Fₚᵤₘₚ(t)*Pᵢₙₜ(t)
Step 2: mathematical integration of A(t) over the duration of the pump activation Δt_{act}, a parameter depending on the air volume Vₐᵢᵣ(t), in order to obtain B(t).

B(t)=∫₀^{Δt}^{_{act}}A(t)·dt
Step 3: multiplication of B(t) by the vapor dome volume V_{dome}(t), in order to obtain C(t).

C(t)=B(t)*V_{dome}(t)

If the value C(t) is greater than the predetermined threshold, then the method comprises the step of indicating that at least one internal reinforcement element may be broken.

If not, no signal indicating that at least one internal reinforcement element connecting at least two opposed walls of the liquid tank may be broken is sent.

The invention also relates to a vehicle liquid tank comprising control means configured to implement the method as described above.

The invention also relates to a vehicle comprising a liquid tank and control means configured to implement the method as described above.

The invention also relates to a computer-readable medium comprising instructions which, when executed by a computer, cause the computer to carry out the steps of the method as described above.

The above and other characteristics, features and advantages of the present invention will become apparent from the following detailed description, taken in conjunction with the accompanying drawings, which illustrate, by way of examples, the principles of the invention. The reference figures quoted below refer to the attached drawings wherein:

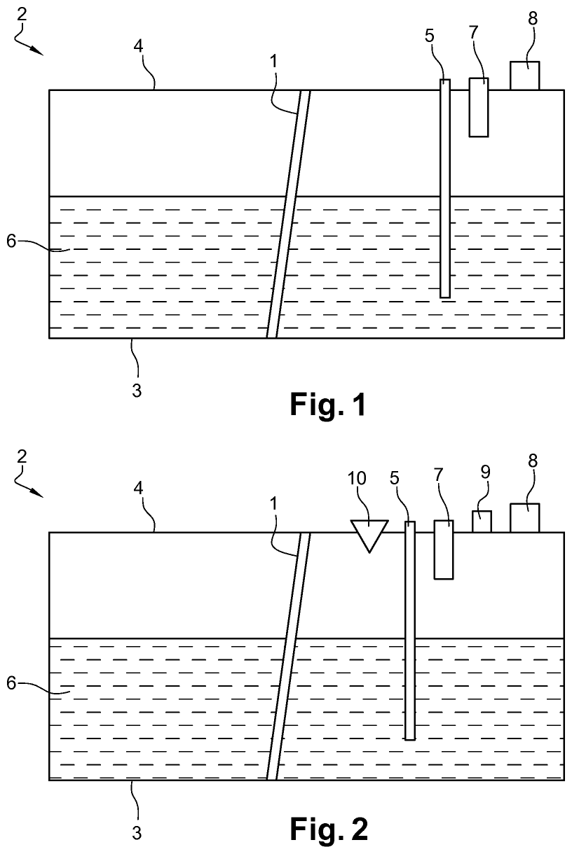

FIG. 1 is a schematic view of one embodiment of a tank which may be used for implementing a method according to the invention;

FIG. 2 is a schematic view of another embodiment of a tank which may be used for implementing a method according to the invention;

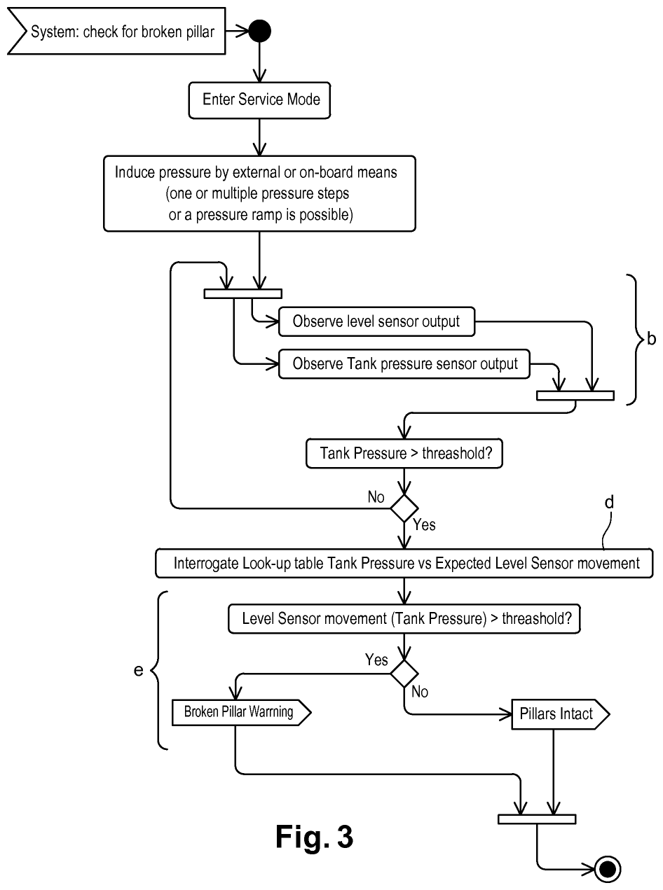

FIG. 3 is a flowchart showing a first embodiment of a method according to the invention;

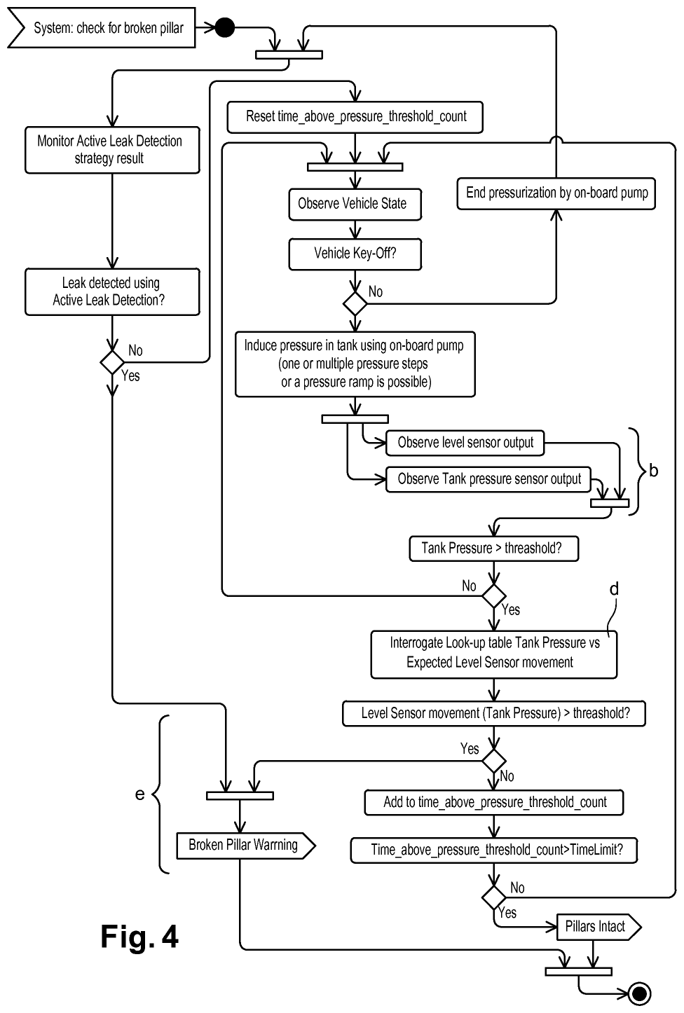

FIG. 4 is a flowchart showing a second embodiment of a method according to the invention; and

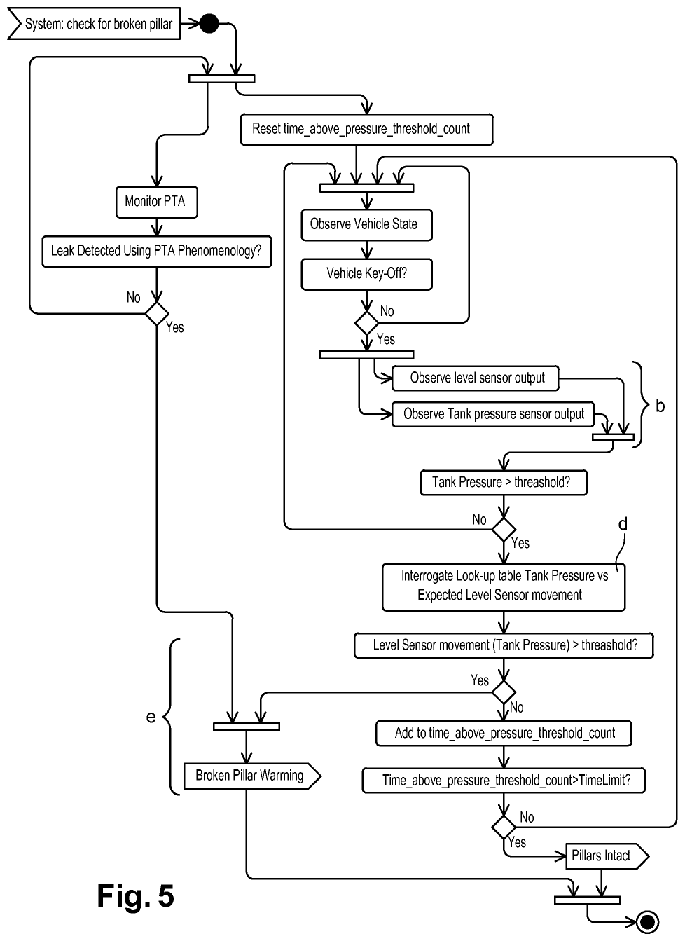

FIG. 5 is a flowchart showing a third embodiment of a method according to the invention.

The present invention will be described with respect to particular embodiments and with reference to certain drawings but the invention is not limited thereto.

### First Embodiment (FIGS. 1 and 3)

The first embodiment describes a method for testing a state of at least one internal reinforcement element 1 of a liquid tank 2 of a vehicle wherein the internal reinforcement element 1 connects at least two opposed walls of the liquid tank 2, preferably the bottom and the top walls 3, 4. For example, the reinforcement element 1 is a pillar.

The tank 2 has a level sensor 5 for measuring a level of liquid 6 inside the tank 2.

The tank 2 has a pressure sensor 7 for measuring an internal pressure of the tank 2.

The tank 2 is associated to control means 8 which are able to process the data provided by the level sensor 5 and the pressure sensor 7 and to command the steps of the method.

The tank 2 comprises at least an initial amount of liquid 6 measurable by the level sensor 5. For example, the tank 2 comprises at least 2 mL of liquid 6, for example 20 L of liquid 6. A first threshold is determined by the control means 8 based on the initial amount of liquid 6 measured by the level sensor 5 and an initial internal pressure of the liquid tank 2 measured by a pressure sensor 7 (step a, not shown). For example, the first threshold may be determined using a bi-dimensional lookup table using the initial internal pressure and the initial amount of liquid as input data.

The method is triggered by an operator when the vehicle is in a service mode and the power of the vehicle is off. After the method has been triggered, a pressure inside the tank is increased by external means, for example by an external pump, inducing an overpressure inside the tank. Of course, it may be provided that a pressure inside the tank is increased using other means, such as means forming part of the vehicle. One or multiple steps of increase of pressure are possible, as well as a progressive increase of pressure (pressure ramp). In another embodiment, it may be provided that a decrease in pressure, inducing a depression inside the tank, is used. For example, such a depression may be induced by an external pump.

The pressure and the liquid level are monitored by the control means with the sensors (step b) until a tank pressure measured by the pressure sensor 7 is above the first threshold.

If the pressure sensor 7 output is above the first threshold, a second threshold and a third threshold are determined by the control means 8 as a function of the pressure sensor 7 output, the initial level sensor 5 output and the initial internal pressure sensor 7 output (step c, not shown). For example, the second and third thresholds may be determined using a tri-dimensional lookup table using the pressure sensor 7 output, the initial level sensor 5 output and the initial internal pressure sensor 7 output as input data. It may be provided that the lookup table comprises a fourth dimension consisting in the temperature of the liquid in the tank. As mentioned above, it is thus possible to take into account the thermal expansion of the liquid.

Then, the level sensor 5 output is compared by the control means 8 to the second and third thresholds to see if the level sensor 5 output is different from an expected level value (step d).

If the level sensor 5 output is above the second threshold, this could indicate that the internal reinforcement element 1 (or at least one of the internal reinforcement element 1) is broken. Thus, a signal indicating that at least one internal reinforcement element 1 is or may be broken is sent (step e). Preferably, the signal is sent to the driver in a first time. The signal may be a visual signal, for example the signal may consists in a light or a message displayed on the dashboard. The signal, which corresponds to a diagnostic, may be stored on a storage medium to alert an operator of a garage during internal electrical check of the car.

If the level sensor output is below the third threshold, this could indicate that the internal reinforcement element 1 (or at least one of the internal reinforcement element 1) is broken. Thus, a signal indicating that at least one of the internal reinforcement element is or may be broken is sent.

If the level sensor 5 output is below the second threshold and above the third threshold, this could indicate that the pillar 1 is intact. Thus, it may be provided that a signal indicating that the internal reinforcement element 1 (or at least one internal reinforcement element 1) is intact is sent.

### Second Embodiment (FIGS. 2 and 4)

In this embodiment, the method is also for testing a state of at least one internal reinforcement element 1 of a liquid tank 2 of a vehicle wherein the internal reinforcement element 1 connects at least two opposed walls of the liquid tank, preferably the bottom 3 and the top 4 walls. For example, at least one reinforcement element is a pillar.

The tank 2 may for example be identical to the one presented above in relation to the first embodiment.

A first step of the method consists in performing a leak detection method. In the present case, the leak detection method used is an active leak detection method. Of course, it is provided that any suitable leak detection method may be used, for example the leak detection methods described in WO 2018/002054 or WO 2013/164463, the content of which is herein incorporated by reference.

If the result of the leak detection method indicates that a leak may exist, then a predetermined signal indicating that at least one internal reinforcement element 1 is or may be broken is sent by the control means 8. Indeed, this result may be a false positive result which in fact is due to a broken internal reinforcement element 1. An operator may subsequently perform further investigations in order to validate or invalidate the existence of a leak in the tank. If a leak appears not to be present, then there is a high probability that the leak detection result is due to a broken reinforcement element.

If the result of the leak detection method indicates that there is no leak in the tank 2, then a counter 9, for example a predetermined counter 9 of the control means 8, is reset and a state of the vehicle is observed.

The tank 2 comprises at least an initial amount of liquid 6 measurable by a level sensor 5. For example, the tank comprises at least 2 mL of liquid 6, for example 20 L of liquid 6. A first threshold is determined by the control means 8 based on the initial amount of liquid 6 measured by the level sensor 5 and an initial internal pressure of the liquid tank 2 measured by a pressure sensor 7 (step a, not shown). For example, the first threshold may be determined using a bi-dimensional lookup table using the initial internal pressure and the initial amount of liquid as input data.

If a power of the vehicle is on, a valve or a pump 10 is activated in order to release pressure from the inside of the tank 2 and the method may be carried out again from the leak detection step. The valve is for example a FTIV or an E-valve. If the power of the vehicle is off, then the control means 8 command an increase of a pressure inside the tank using, for example, means forming part of the vehicle such as an on-board pump. This results in an overpressure inside the tank 2. One or multiple increases of pressure steps are possible, as well as a progressive increase of pressure (pressure ramp). In another embodiment, it may be provided that a decrease of pressure, inducing a depression inside the tank 2, is used. For example, such a depression may be induced by an on-board pump.

The pressure and the liquid level are monitored by the control means 8 and the sensors 5, 7(step b) until a tank pressure measured by the pressure sensor 7 is above the first threshold.

If the control means 8 determines that the pressure sensor 7 output is above the first threshold, a second threshold and a third threshold are determined by the control means 8 as a function of the pressure sensor 7 output, the initial level sensor 5 output and the initial internal pressure sensor 7 output (step c, not shown). For example, the second and third thresholds may be determined using a tri-dimensional lookup table using the pressure sensor 7 output, the initial level sensor 5 output and the initial internal pressure sensor 7 output as input data. It may be provided that the lookup table comprises a fourth dimension consisting in the temperature of the liquid in the tank. As mentioned above, it is thus possible to take into account the thermal expansion of the liquid.

Then, the control means 8 compares the level sensor output to the second and third thresholds to see if the level sensor output is different from an expected level value (step d).

If the level sensor output is above the second threshold, this could indicate that the internal reinforcement element 1 (or at least one of the internal reinforcement element 1) is broken. Thus, a signal indicating that at least one internal reinforcement element 1 is or may be broken is sent (step e).

If the level sensor 5 output is below the third threshold, this could indicate that the internal reinforcement element 1 (or at least one of the internal reinforcement element 1) is broken. Thus, a signal indicating that at least one internal reinforcement element 1 is or may be broken is sent (step e, not shown).

If the level sensor 5 output is below the second threshold and above the third threshold, the counter 9 is incremented. If the counter 9 is below a fourth predetermined threshold, at least the steps a), b) and c) of the method are performed again under the command of the control means 8, preferably with a plurality of first thresholds. If the counter 9 is above the fourth threshold, the method comprises a step of sending a signal indicating that at least one internal reinforcement element 1 connecting the opposed walls 3, 4 is not broken.

### Third Embodiment (FIGS. 2 and 5)

The third embodiment is identical to the second embodiment except for the below discussed points.

In the third embodiment, the leak detection method is not an active leak detection method but a method based on pressure and temperature analysis such as the one described in EP17305638. Furthermore, the leak detection test is performed by the control means 8 in parallel to the testing of the state of at least one internal reinforcement element 1 of the liquid tank 2 of a vehicle. Thus, contrary to the second embodiment, the test is performed even if the leak detection method detects a leak.

In the third embodiment, there is no step of actively increasing the internal pressure in the tank after observing that the power of the vehicle is off. Instead, the monitoring step b) relies on an increase or a decrease of pressure inside the tank 2 generated solely by an increase or a decrease of an external tank temperature. When the ambient temperature is increased, the pressure inside the tank is increased. When the ambient temperature is decreased, the pressure inside the tank is decreased.

In the same way as for the second embodiment, the temperature and the liquid level inside the tank 2 are monitored by the control means 8 until the pressure sensor 7 output is above the first threshold and all of the subsequent steps are identical to those of the second embodiment.

Whilst the principles of the invention have been set out above in connection with specific embodiments, it is to be understood that this description is merely made by way of example and not as a limitation of the scope of the invention which is determined by the appended claims.

1. A method for testing the state of at least one internal reinforcement element of a liquid tank of a vehicle, said at least one internal reinforcement element connecting at least two opposed walls of the liquid tank, the liquid tank comprising at least an initial amount of liquid measurable by a level sensor, the method comprising:
a) determining a first threshold based on the initial amount of liquid measured by the level sensor and an initial internal pressure of the liquid tank measured by a pressure sensor;
b) monitoring a level sensor output and a pressure sensor output;
c) if the pressure sensor output is above the first pressure threshold, determining a second level threshold and a third level threshold as a function of the pressure sensor output, the initial level sensor output and the initial internal pressure sensor output;
d) comparing the level sensor output to the second and third level thresholds;
e) if the level sensor output is above the second level threshold, sending a first predetermined signal indicating that at least one internal reinforcement element connecting the opposed walls is or may be broken, and/or
if the level sensor output is below a third level threshold, sending a second predetermined signal indicating that at least one internal reinforcement element connecting the opposed walls is or may be broken.

2. The method according to claim 1, wherein, during step c), the determination of the second and third thresholds is done also as a function of a temperature of the liquid in the tank.

3. The method according to claim 1, comprising incrementing a counter if the level sensor output is between the second threshold and the third threshold.

4. The method according to claim 3, wherein, if the counter (9) is below a fourth predetermined threshold, at least the steps a), b) and c) are performed again, preferably with a plurality of first thresholds.

5. The method according to claim 4, wherein, if the counter is above the fourth threshold, the method comprises sending a signal indicating that at least one internal reinforcement element connecting the opposed walls is not broken.

6. The method according to claim 1, wherein the monitoring step b) relies on an increase or a decrease of pressure inside the tank generated solely by an increase or a decrease of an external tank temperature.

7. The method according to claim 1, wherein the monitoring step b) comprises commanding means for increasing or decreasing pressure inside the tank, preferably in response to a signal from a vehicle crash sensor.

8. The method according to claim 7, wherein the commanding means for increasing or decreasing pressure inside the tank is performed by:
using an external pump not forming part of the vehicle;
using a means forming part of the vehicle, for example a pump or a heater, and/or
commanding a release of the internal tank pressure using a valve of the tank.

9. The method according to claim 1, wherein the method is performed when a power of the vehicle is off, preferably only when a power of the vehicle is off.

10. The method according to claim 1, wherein the method is triggered when the vehicle is in a service mode.

11. The method according to claim 1, wherein a leak detection step is performed before step a).

12. (canceled)

13. A vehicle liquid tank comprising control means configured to implement the method of claim 1.

14. A vehicle comprising a liquid tank and control means configured to implement the method of claim 1.

15. A computer-readable medium comprising instructions which, when executed by a computer, cause the computer to carry out the steps of the method according to claim 1.
